(19) United States
(12) Patent Application Publication
(10) Pub. No.: US 2015/0035415 A1
(43) Pub. Date: Feb. 5, 2015

(54) Automatic Permanent Magnet Electrical Machinery

(71) Applicant: Minghua Zang, Xian (CN)

(72) Inventor: Minghua Zang, Xian (CN)

(21) Appl. No.: 14/089,777

(22) Filed: Nov. 26, 2013

Related U.S. Application Data
(63) Continuation-in-part of application No. 13/957,458, filed on Aug. 2, 2013.

(51) Int. Cl. H02K 1/27; H02K 5/16

(52) U.S. Cl. CPC H02K 1/27; H02K 5/16; Y10S 74/09; H02K 53/00
USPC 310/68 R; 310/89; 74/DIG. 9

(57) ABSTRACT

The invention is an automatic permanent magnet electrical machinery that does not need any other energy and can be used as an electromotor or a generator. It consists of a shell that installed with stator cores and a rotor as well as a control circuit. The shell consists of a top lid, a bottom lid and a shell body. The stator cores are made by soft magnetic material with the shape of c. The 3 coils are circled in the middle, top and bottom part of each stator core separately. The rotor is consists of a principal axis and many vanes. A vane of the rotor is consists of a rotor core and a magnet embedded in the rotor core and fixed with no magnetism plate. The principal axis and the rotor cores are integral whole. Rotor core is made by soft magnetism material. The circuit is consists of switches, coils, electrical appliance, a battery and a rectifying switching mode power supply.

### CROSS-REFERENCE TO RELATED APPLICATION

Provisional Application No. 61/683,683

Filing Date Aug. 15, 2012
Applicant Minghua Zang
Non-Provisional application Ser. No. 13/957,458
Filing Data Aug. 2, 2013
Applicant Minghua Zang

### BACKGROUND OF THE INVENTION

The invention is the automatic permanent magnet electrical machinery that can be used as an electromotor or a generator and does not need any other energy.

Now, generators and motors consume a mass of energy resource. The most of the resource come from petroleum and coal, it pollute environment. Clean energy resource, such as sun and wind resource, can hardly be prevalent, because of high cost of equipment.

Base on theory in affix 1 and affix 2 (see following paragraph), the automatic permanent magnet electrical machinery is designed to eliminate the impact of counterforce by the principle that the magnetic flux of reverse magnetic field changes gradually in soft magnetic material, it does not cancel out.

### (Affix 1) Research on the Principle, Model and Example of Non-Conservative Mechanical Energy

The mechanical energy conservation law is not only proved by theory, but also proved by practice. But when using the mechanical energy conservation law, we doubt about heat death it rising. The misgivings bring the new thought about the mechanical energy conservation law. Start with the premise of mechanical energy conservation law, investigate preconditions of its tenability theoretically; probe into the theory of non-conservative mechanical energy; bring forward physical model of non-conservative mechanical energy; analyze an example of non-conservative mechanical energy in the nature.

There are two preconditions of the mechanical energy conservation law. One is the force and counterforce law, another one is the conservative force field. When two moving objects acting on each other, the force and counterforce law is the precondition of the mechanical energy conservation law. When one moving object in conservative force filed, the property of conservative force filed is the precondition of the mechanical energy conservation law.

Since there are two preconditions for the mechanical energy conservation law, if its preconditions do not meet, the mechanical energy conservation law can not be proved.

First, when two moving objects acting on each other, due to the force and counterforce law, and because the force, time and distance of interactional force are equal, but direction is opposite, so mechanical energy is constant. But, when two moving objects acting on each other, or at end of the acting, the kinetic energy of either one translates into another kind of energy (example: heat), or the energy be blocked, while the systemic energy dos not change, its systemic mechanical energy (kinetic energy) is changed. This means the energy to outside system has changed. The change is the result of internal force; this is significant to non-conservative mechanical energy. In a container there are two objects having the same velocity, and the same mass but opposite direction. The momentum and kinetic energy of the system is zero. But if the kinetic energy of either one translates into the another kind of energy (example: heat), or the energy be blocked, the mechanical energy (kinetic energy) will be inconstant. The kinetic energy of the system is not zero. The system has the energy to outside. In a system with many moving objects, as long as unbalanced mechanical energy change takes place, or the mechanical energy is controlled in unbalanced direction, internal force will become work force, this is a precondition to non-conservative mechanical energy, and this is also the case that the force and counterforce law does not work (see FIG. 4).

In FIG. 5, big molecule gas is isolated by the two sieves (2) between them, because the hole size of the sieves, it only allow the tiny molecule of liquid to pass, does not allow the big molecule of gas to pass. Under the pressure of gas, liquid pass the bottom sieve and rise to the top sieve (potential energy increase). When liquid pass the top sieve, it congeals, falls and releases energy. As the process continued, energy releases continued. The reason for this is that upward pressure is obstructed, downward pressure works. It is hard to happen because of friction and adsorption. But, a precondition of non-conservative mechanical energy has been showed, because in a change process of energy, we do not regard to friction and adsorption in the point of the mechanical energy conservation law.

Water can be as high as mountains, its physic principle can be explained by the physic model.

Hereinbefore bring forward theoretic reason of non-conservative mechanical energy by discussing the precondition of the mechanical energy conservation law. There is also an example of the non-conservative force filed.

Raining process has 4 steps, gasification, rise, coagulation and fall. The absorbing energy in gasification step and the ejective energy in coagulation step are equal. Where the potential energy come from? When the vapor rises, two kinds of forces affect it, aerial buoyancy and gravity, the buoyancy is greater than the gravity, the direction of the composition of forces is upward; when the water falls down, the gravity is greater than buoyancy, the direction of the composition of forces is downward. This is an example of the non-conservative force filed.

The same as that there are two preconditions for the mechanical energy conservation law, there are two contrary preconditions for the non-conservative mechanical energy. In a system with many moving objects, the precondition of non-conservative mechanical energy is unbalanced mechanical energy change take place, or the mechanical energy be controlled in unbalanced direction; the non-conservative force filed is another precondition of non-conservative mechanical energy. Because the unbalanced mechanical energy change and the non-conservative force filed are impersonal, non-conservative mechanical energy is impersonal. We have to meet the one of the preconditions of the non-conservative mechanical energy, as we have to meet it of the mechanical energy conservation law, for us to use it.

### (Affix2) the Magnetic Flux of Reverse Magnetic Field Changes Gradually in Soft Magnetic Material

The magnetic flux of reverse magnetic field changes gradually in soft magnetic material. In the FIG. 6, a and b are automatic permanent magnets, c is soft magnetic iron cone. When the magnets flux of two magnets Is equal in the quantity, but opposite in direction, the magnetic flux in soft magnetic material is not constant, and the reverse magnetic field dos not counteract each other, but it change gradually in soft magnetic material as the FIG. shows. The gravitation between a magnet and the one end of soft magnetic material dos not change if there is another opposite magnet on the another end of the soft magnetic material. The reason is that the magnetic flux of reverse magnetic field changes gradually in soft magnetic material. This eliminates the force of reverse magnetic field. If reverse magnetic field is brought by the same magnet, it eliminates the counterforce of the magnetic field.

If field density of two reverse magnets is not equal, magnetic flux in soft magnetic material of each magnet will not be equal and dot c will not be in the middle of the soft magnetic material. Here put forward a envisage of the opposite lever: B1/ac=B2/cb; B1 is density of the magnetic flux of the magnet a in soft magnetic material; B2 is the density of the magnetic flux of the magnet b in soft magnetic material; ac is the distance between magnet a and c (0 magnetic flux); cb is the distance between magnet b and c (0 magnetic flux). The soft magnetic material has to be long enough.

### BRIEF SUMMARY OF THE INVENTION

The invention is the automatic permanent magnet electrical machinery that does not need any other energy and can be used as an electromotor or a generator. It consists of a shell that installed with stator cores and a rotor as well as a control circuit (FIG. 1, FIG. 2).

The shell consists of a top lid, a bottom lid and a shell body. The top lid has bolt holes and partition girders locking stator cores. The bottom lid has a bearing seat, bolt holes, partition girders locking the stator cores and the holes for wire. The shell body also has bolt holes on each side to fix the top lid, the bottom lid and itself together with bolts. The shell body also has holes on the bottom for wire. Stator cores are made by soft magnetic material with the shape of c. 3 coils are circled in the middle, top and bottom part of each stator core separately. The coil on the top part of each stator core is at the top end of the stator core and can be divided to two parts. The coil on the bottom part of each stator core is at the bottom end of the stator core and can be divided to two parts. The number of the circles of a coil in the middle of each stator core is greater than the total number of the circles of the coils in the top and bottom of the stator core. The coil in the middle of each stator core is series connected to the coils in the top and bottom of the stator core through a group switch of three. The wound directions of the coil in the middle of each stator core and the coils in the top and bottom of the stator core are opposite. The principal axis is installed in the bearings in the bottom lid and a motor. The rotor is consists of the principal axis and many vanes. A vane of the rotor is consists of a rotor core and a magnet embedded in the rotor core and fixed with no magnetism plate. The principal axis and the vanes of the rotor are integral whole. Rotor core is made by soft magnetism material. The principal axis and the vanes of the rotor are fixed with two no magnetism plate.

Another scheme for the position of the rotor core and stator cores is to put the rotor core and stator cores horizontally (FIG. 3), the plate shape automatic permanent magnet electrical machinery. The principle of the design is the same. The difference is top and bottom of the stator core and the rotor core become front and rear, as well as coils on them. And front and rear position of the coils of the stator core changes as the rotor core turning. The connection between the middle coil and front and rear coils is controlled by a PLC. The rotor core and magnet are fixed with two no magnetism plates on top and bottom of them. The stator cores with round shape are fixed in the shell by the stator cores seats and bolts on the lids.

The features of the invention are no other energy needed, no pollution, simple structure and economical.

### BRIEF DESCRIPTION OF SEVERAL VIEWS OF THE DRAWING

FIG. 1 is the structural representation and overlook view of the structural representation of the automatic permanent magnet electrical machinery.

The automatic permanent magnet electrical machinery is consists of a shell (1, 20, 17) that installed with stator cores (3) and a rotor, as well as a control circuit. The shell (1, 20, 17) consists of the top lid (1), the bottom lid (17) and the shell body (20). The top lid (1), bottom lid (17) and shell body (20) have bolt holes to fit together with bolts (22). The top lid (1) and the bottom lid (17) have partition girders (2) to lock stator cores (3). The bottom lid (17) and shell body (20) have group holes (21), each group has 2 holes (21) for the wire of coils (19, 4, 18) to connect to the control circuit. The bottom lid (17) have a bearing seat (14) to put the bearing (15). The bottom lid has machine seats (12). The stator cores (3) are made by soft magnetic material with the shape of c, and are blocked between the top lid (1) and the bottom lid (17) by partition girders (2) and bolts (9) on each side. There are 3 coils (19, 4, 18) in the middle, top and bottom of each stator core (3) separately. The coil (19) in the middle of each stator core (3) has a distance with the coil (4) on the top part of the stator core (3) and a distance with the coil (18) on bottom part of the stator core (3). The coil (4) on the top part of each stator core (3) is at the top end of the stator core (3) and can be divided to two parts (4a,4b). The coil (18) on bottom part of each stator core (3) is at the bottom end of the stator core (3) and can be divided to two parts (18a,18b). The number of the circles of the coil (19) in the middle of each stator core (3) is greater than total number of the circles of the coils (4,18)in the top and bottom of the stator core (3). The coil (19) in the middle of each stator core (3)is series connected to the coils (4,18) in the top and bottom of the stator core (3) through the group switch of three (23). The wound directions of the coil (19) in the middle of each stator core (3) and the coils (4,18) in the top and bottom of the stator core (3) are opposite, this means when series connected, the directions of the electric current produced in the coil (19) in the middle of the stator core (3) and the electric current produced in the coils (4b,18b) on the top and bottom of the stator core (3) are opposite. The rotor is consists of the principal axis (13) and many vanes (8,11). A vane (8,11) of the rotor is consists of a rotor core (8) and a magnet (11) embedded in the rotor core (8) and fixed with no magnetism plate (10). The rotor core (8) is made by soft magnetism material. The principal axis (13) and the vanes (8,11) of the rotor are fixed with two no magnetism plate (7,16).

When a vane (8,11) of the rotor is entering into the position to face with a stator core (3) or leave from position of a stator core (3), due to the changing magnetic flux in the stator core (3), electric current is produced in the coil (19) in the middle of stator core (3) and the coils (4,18) on the top and bottom of the stator core (3). Because the number of the circles of the coil (19) in the middle of the stator core (3) is greater than the total number of the circles of the coils (4,18) in the top and bottom of the stator core (3) and the wound directions of the coil (19) in the middle of the stator core (3) and the coils (4,18) in the top and bottom of the stator core (3) are opposite, The magnetic force of electric current of the coils (4,18) repulses or pull the vane of the rotor that leave from or come to the position of the stator core, so the vane of the rotor turns continually and the automatic permanent magnet electrical machinery can export electricity to electrical appliance (27) or charge the battery (30) passing through the rectifying switching mode power supply 28) continually.

FIG. 2 is the circuit of the automatic permanent magnet electrical machinery of one pair of the coils (19, 4, 18) in the middle of the stator core (3) and on the top and bottom of the stator core (3). But, because other pairs of the coils (19, 4, 18) in the middle of the stator core (3) and on the top and bottom of the stator core (3) are parallel connected in the circuit through the rectifying switching mode power supplies (28), so FIG. 2 can represents the circuit of the automatic permanent magnet electrical machinery.

The circuit is consists of a group switch of two (23a,23b) with three positions, a coil (19) in the middle of the stator core (3), coils (4,18) on the top and bottom of the stator core (3), five independent switches (24, 25, 26, 29, 31), electrical appliance, a battery (30) and a rectifying switching mode power supply (28). The coil (4) on the top part of the stator core (3) is at the top end of the stator core (3) and can be divided to two parts (4a,4b). The coil (18) on bottom part of the stator core (3) is at the bottom end of the stator core (3) and can be divided to two parts (18a,18b). The number of the circles of the coil (19) in the middle of each stator core (3) is greater than total number of the circles of the coils (4,18)in the top and bottom of the stator core (3). The coil (19) in the middle of each stator core (3) is series connected to the coils (4,18) in the top and bottom of the stator core (3) through a group switch of three (23). The wound directions of the coil (19) in the middle of the stator core (3) and the wound directions of the coils (4,18) in the top and bottom of the stator core (3) are opposite, this means when series connected, the directions of the electric current produced in the coil (19) in the middle of stator core (3) and the electric current produced in the coils (4b,18b) on the top and bottom of the stator core (3) are opposite.

The principle of the operation

1, To start the automatic permanent magnet electrical machinery. Turn the switch (31) on, the automatic permanent magnet electrical machinery is started by motor (5).

2, To operate the automatic permanent magnet electrical machinery as a generator.

After it starts, turn the group switch (23a,23b) on to the generator (bottom) position; turn switch (25) and switch (26) on, turn the starts switch (31) off. When a vane (8,11) of the rotor is entering into the position to face with a stator core (3) or leave from the position of a stator core (3), due to changing magnetic flux in the stator core (3), electric current is produced in the coil (19) in the middle of the stator core (3) and the coils (4b,18b) on the top and bottom of the stator core (3). Because the number of the circles of the coil (19) in the middle of the stator core (3) is greater than total number of the circles of the coils (4,18) in the top and bottom of the stator core (3) and the wound directions of the coil (19) in the middle of the stator core (3) and the coils (4,18) in the top and bottom of the stator core (3) are opposite, the magnetic force of electric current of the coils (4,18) repulses or pull the vane of the rotor that leave from or come to the position of the stator core, so the vane of the rotor turns continually and the automatic permanent magnet electrical machinery export electricity to electrical appliance (27).

3, To operate the automatic permanent magnet electrical machinery as a motor.

After it starts, turn the group switch (23a,23b) on to the motor (middle) position; turn switch (24) on, turn the starts switch (31) off. When a vane (8,11) of the rotor is entering into the position to face with a stator core (3) or leave from the position of a stator core (3), due to changing magnetic flux in the stator core (3), electric current is produced in the coil (19) in the middle of stator core (3) and the coils (4,18) on the top and bottom of the stator core (3). Because the number of the circles of the coil (19) in the middle of the stator core (3) is greater than total number of the circles of the coils (4,18) in the top and bottom of the stator core (3); the wound directions of the coil (19) in the middle of the stator core (3) and the coils (4,18) in the top and bottom of the stator core (3) are opposite; the magnetic force of electric current of the coils (4,18) repulses or pull the vane of the rotor that leave from or come to the position of the stator core, so the vane of the rotor turns continually.

4, Charge

After it starts, turn the group switch (23a,23b) on to the generator (bottom) position; turn the switch (26) and the switch (29) on, turn the starts switch (31) off. When a vane (8,11) of the rotor is entering into the position to face with a stator core (3) or leave from the position of a stator core (3), due to changing magnetic flux in the stator core (3), electric current is produced in the coil (19) in the middle of the stator core (3) and the coils (4b,18b) on the top and bottom of the stator core (3). Because the number of the circles of the coil (19) in the middle of the stator core (3) is greater than total number of the circles of the coils (4,18)in the top and bottom of the stator core (3); the wound directions of the coil (19) in the middle of the stator core (3) and of the coils (4,18) in the top and bottom of the stator core (3) are opposite, the magnetic force of electric current of the coils (4,18) repulses or pull the vane of the rotor that leave from or come to the position of the stator core, so the vane of the rotor turns continually and the automatic permanent magnet electrical machinery export electricity to the battery (30) passing through the rectifying switching mode power supply (28) continually.

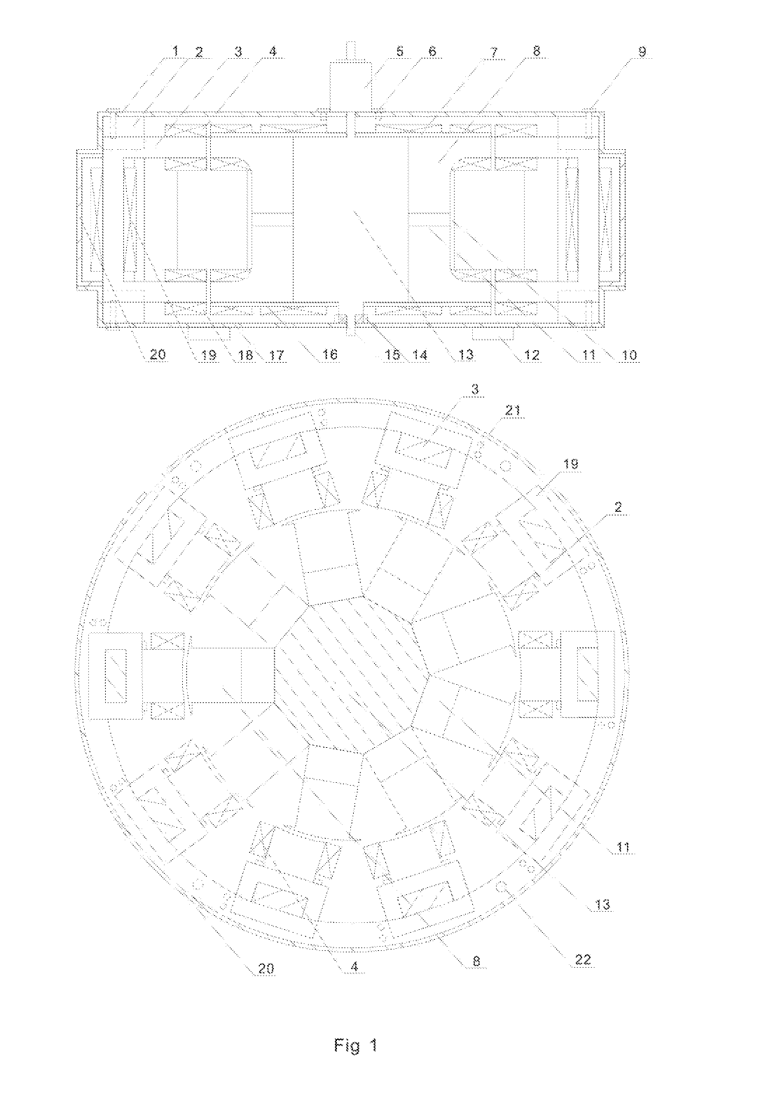

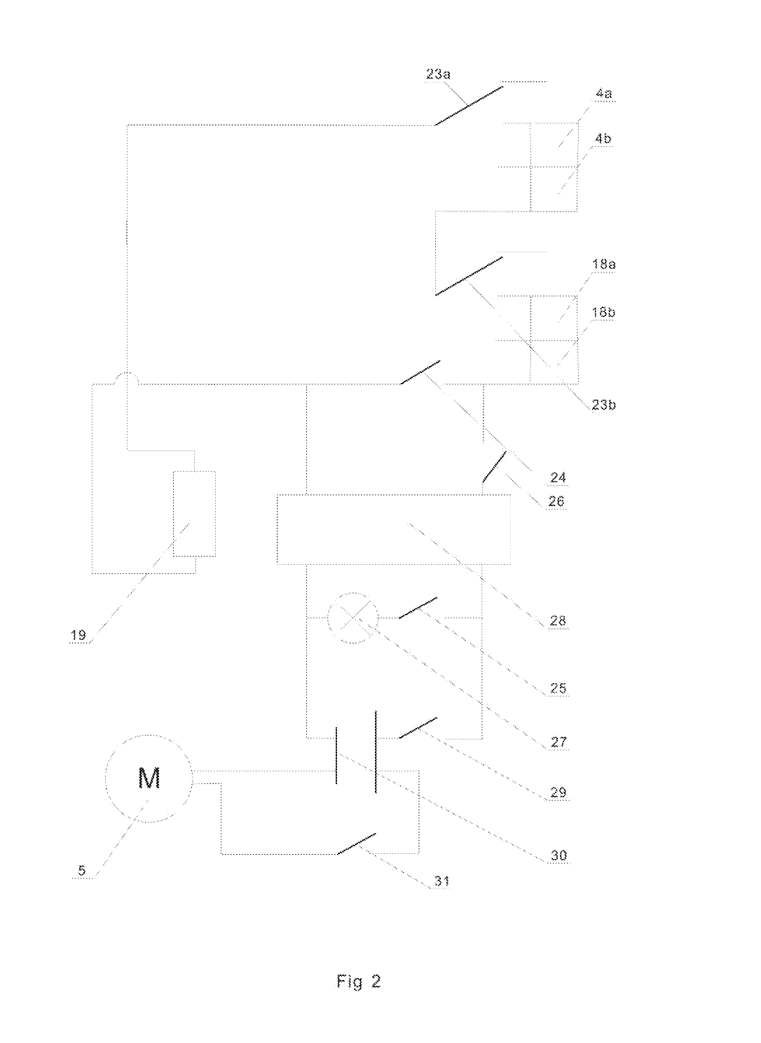

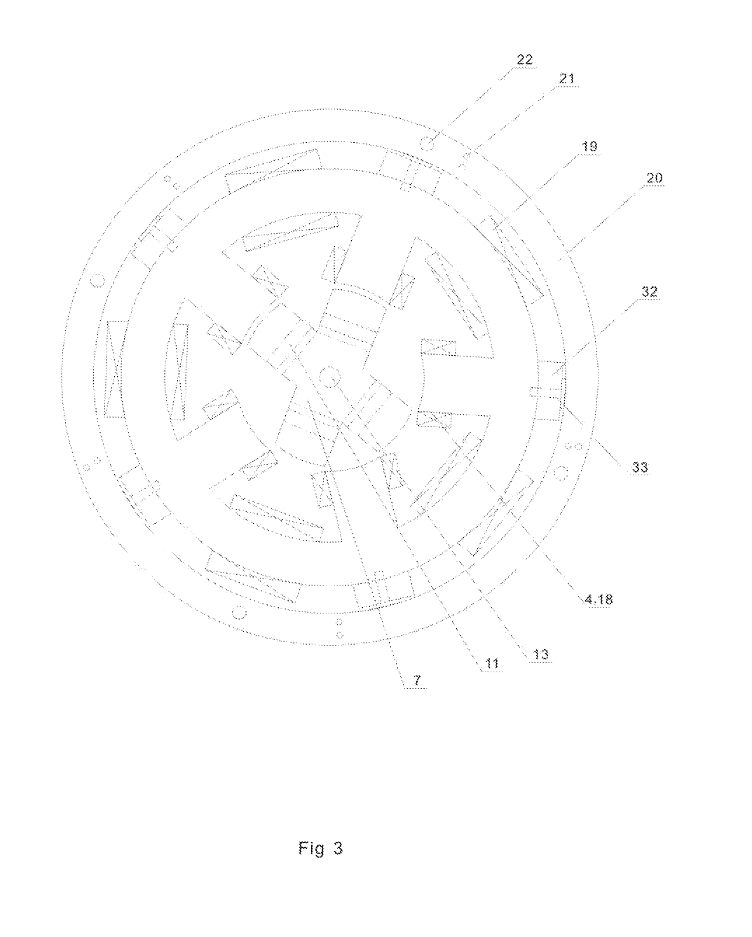

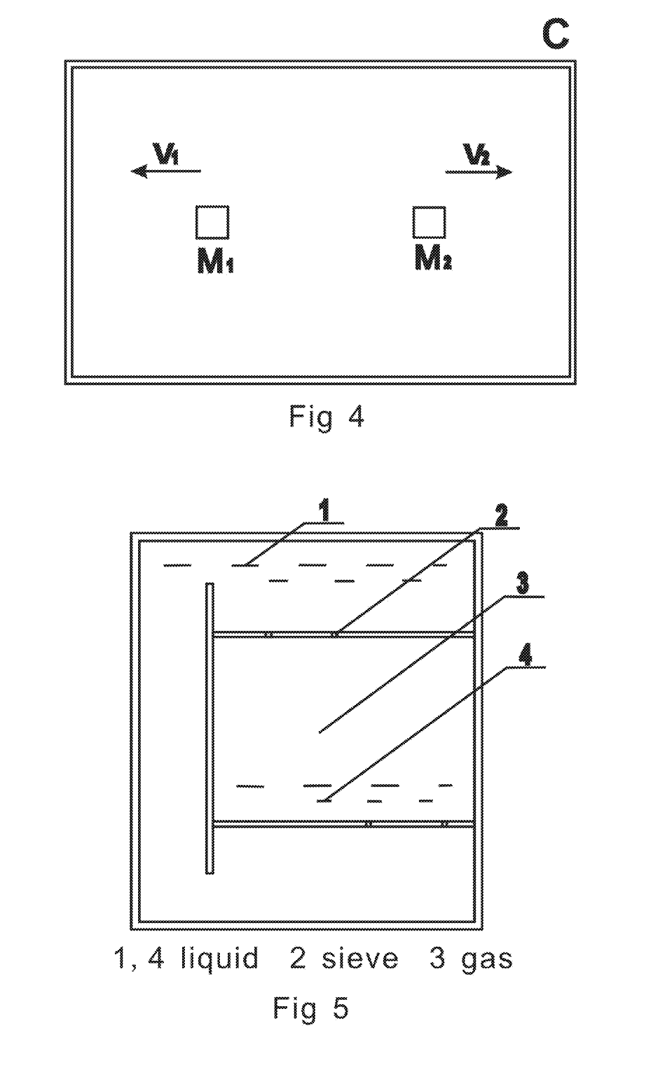

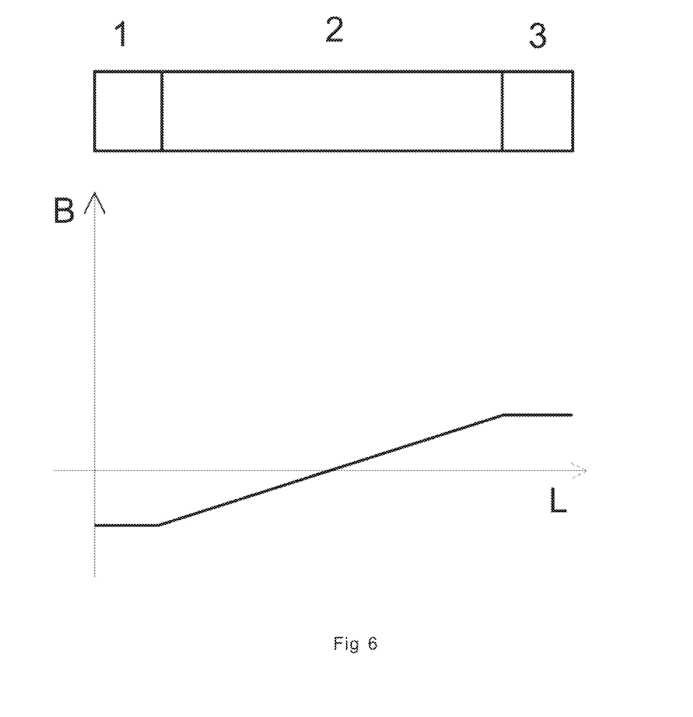

FIG. 3 is the structural representation of the plate shape automatic permanent magnet electrical machinery (use the same mark for the same part with FIG. 1 and FIG. 2).

The only difference of the plate shape automatic permanent magnet electrical machinery is to put the vane (8,11) of the rotor and stator cores (3) horizontally, the plate shape automatic permanent magnet electrical machinery. The principle of the design is the same. The difference is the top and bottom of the stator cores (3) and that of the vanes (8,11) of the rotor become front and rear, as well as coils (4,18) on them. And the front and rear position of the coils (4,18) of the stator cores (3) changes as the rotor turning. The connection between a middle coil (19) and front and rear coils (4, 18) is controlled by a PLC. The rotor core (8) and magnet (11) are fixed with no magnetism plates (10). The vanes of the rotor and the principal axis (13) are fixed with two no magnetism plates (7,16) on top and bottom of them. The stator cores (3) with round shape are fixed in the shell (20) by the stator cores seats (32) and bolts (33) on the bottom lid (17).

FIG. 4 shows In a container there are two objects having the same velocity and the same mass, but opposite direction.

FIG. 5 shows big molecule gas is isolated between two sieves, it only allow the tiny molecule of liquid to pass.

FIG. 6 shows the reverse magnetic field dos not counteract each other, but it change gradually in soft magnetic material.

### DETAILED DESCRIPTION OF THE INVENTION

The automatic permanent magnet electrical machinery is consists of a shell (1, 20, 17) that installed with stator cores (3) and a rotor, as well as a control circuit. The shell (1, 20, 17) consists of a top lid (1), a bottom lid (17) and a shell body (20). The top lid (1), bottom lid (17) and shell body (20) have bolt holes to fit together with boles (22). The top lid (1) and bottom lid (17) have partition girders (2) to lock stator cores (3). The bottom lid (17) and shell body (20) have group holes (21), each group has 2 holes (21), for the wire of the coils (19, 4, 18) to connect to the control circuit. The bottom lid (17) have a bearing seat (14) to put the bearing (15). The bottom lid has three machine seats (12). The stator cores (3) are made by soft magnetic material with the shape of c, and are blocked between top lid (1) and bottom lid (17) by partition girders (2) and bolts (9) on each side. There are 3 coils (19, 4, 18) in the middle, top and bottom of each stator core (3) separately. The coil (19) in the middle of each stator core (3) has a distance with the coil (4) on the top part of the stator core (3) and with the coil (18) on bottom part of the stator core (3). The coil (4) on the top part of each stator core (3) is at the top end of the stator core (3) and can be divided to two parts (4a,4b). The coil (18) on bottom part of each stator core (3) is at the bottom end of the stator core (3) and can be divided to two parts (18a,18b). The number of the circles of the coil (19) in the middle of each stator core (3) is greater than total number of the circles of the coils (4,18) in the top and bottom of the stator core (3). The coil (19) in the middle of each stator core (3) is series connected to the coils (4,18) in the top and bottom of the stator core (3) through a group switch of three (23). The wound directions of the coil (19) in the middle of each stator core (3) and the coils (4,18) in the top and bottom of the stator core (3) are opposite, this means when series connected, the directions of the electric current produced in the coil (19) in the middle of stator core (3) and the electric current produced in the coils (4b,18b) on the top and bottom of the stator core (3) are opposite. The rotor is consists of the principal axis (13) and many vanes (8,11). A vane (8,11) of the rotor is consists of a rotor core (8) and a magnet (11) embedded in the rotor core (8) and fixed with no magnetism plate (10). The number of the vanes (8,11) of the rotor is the number of the stator cores (3) minus or plus one. Rotor core (8) is made by soft magnetism material. The principal axis (13) and the vanes (8,11) of the rotor are fixed with two no magnetism plate (7,16).

When a vane (8,11) of the rotor is entering into the position to face with a stator core (3) or leave from the position of a stator core (3), due to the changing magnetic flux in the stator core (3), electric current is produced in the coil (19) in the middle of stator core (3) and the coils (4,18) on the top and bottom of the stator core (3). Because the number of the circles of the coil (19) in the middle of the stator core (3) is greater than total number of the circles of the coils (4,18) in the top and bottom of the stator core (3) and the wound directions of the coil (19) in the middle of the stator core (3) and the coils (4,18) in the top and bottom of the stator core (3) are opposite, the magnetic force of electric current of the coils (4,18) repulses or pull the vane of the rotor that leave from or come to face the position of the stator core, so the vane of the rotor turns continually and the automatic permanent magnet electrical machinery can export electricity to electrical appliance (27) or charge the battery (30) passing through the rectifying switching mode power supply (28) continually.

The circuit is consists of a group switch of two (23a,23b) with three positions, a coil (19) in the middle of the stator core (3), a series-wound coils (4,18), five independent switches (24, 25, 26, 29, 31), electrical appliance, a battery (30) and a rectifying switching mode power supply (28). The series-wound coils (4,18) is consists of the coil (4) on the top part of the stator core (3) and the coil (18) on bottom part of the stator core (3). The coil (4) on the top part of each stator core (3) is at the top end of the stator core (3) and can be divided to two parts (4a,4b). The coil (18) on bottom part of each stator core (3) is at the bottom end of the stator core (3) and can be divided to two parts (18a,18b). The number of the circles of the coil (19) in the middle of each stator core (3) is greater than total number of the circles of the coils (4,18)in the top and bottom of the stator core (3). The coil (19) in the middle of each stator core (3)is series connected to the coils (4,18) in the top and bottom of the stator core (3) through a group switch of three (23). The wound directions of the coil (19) in the middle of each stator core (3) and the coils (4,18) in the top and bottom of the stator core (3) are opposite, this means when series connected, the directions of the electric current produced in the coil (19) in the middle of a stator core (3) and the electric current produced in the coils (4b,18b) on the top and bottom of the stator core (3) are opposite. The principle of the operation.

1, To start the automatic permanent magnet electrical machinery. Turn the switch (31) on, the automatic permanent magnet electrical machinery is started by motor (5).

2, To operate the automatic permanent magnet electrical machinery as a generator.

After it starts, turn the group switch (23a,23b) on to the generator (bottom) position; turn switch (25) and switch (26) on, turn the starts switch (31) off. When a vane (8,11) of the rotor is entering into the position to face with a stator core (3) or leave from the position of a stator core (3), due to changing magnetic flux in the stator core (3), electric current is produced in the coil (19) in the middle of the stator core (3) and the coils (4b,18b) on the top and bottom of the stator core (3). Because the number of the circles of the coil (19) in the middle of the stator core (3) is greater than total number of the circles of the coils (4,18)in the top and bottom of the stator core (3) and the wound directions of the coil (19) in the middle of the stator core (3) and the coils (4,18) in the top and bottom of the stator core (3) are opposite, the magnetic force of electric current of the coils (4,18) repulses or pull the vane of the rotor that leave from or come to the position of the stator core, so the vane of the rotor turns continually and the automatic permanent magnet electrical machinery export electricity to electrical appliance (27).

3, To operate the automatic permanent magnet electrical machinery as a motor.

After it starts, turn the group switch (23a,23b) on to the motor (middle) position; turn switch (24) on, turn the starts switch (31) off. When a vane (8,11) of the rotor is entering into the position to face with a stator core (3) or leave from the position of a stator core (3), due to changing magnetic flux in the stator core (3), electric current is produced in the coil (19) in the middle of stator core (3) and the coils (4,18) on the top and bottom of the stator core (3). Because the number of the circles of the coil (19) in the middle of the stator core (3) is greater than total number of the circles of the coils (4,18) in the top and bottom of the stator core (3); the wound directions of the coil (19) in the middle of the stator core (3) and the coils (4,18) in the top and bottom of the stator core (3) are opposite; the magnetic force of electric current of the coils (4,18) repulses or pull the vane of the rotor that leave from or come to the position of the stator core, so the vane of the rotor turns continually.

4, Charge

After it starts, turn the group switch (23a,23b) on to the generator (bottom) position; turn the switch (26) and the switch (29) on, turn the starts switch (31) off. When a vane (8,11) of the rotor is entering into the position to face with a stator core (3) or leave from the position of a stator core (3), due to changing magnetic flux in the stator core (3), electric current is produced in the coil (19) in the middle of the stator core (3) and the coils (4b,18b) on the top and bottom of the stator core (3). Because the number of the circles of the coil (19) in the middle of the stator core (3) is greater than total number of the circles of the coils (4,18)in the top and bottom of the stator core (3) and the wound directions of the coil (19) in the middle of the stator core (3) and of the coils (4,18) in the top and bottom of the stator core (3) are opposite, the magnetic force of electric current of the coils (4,18) repulses or pull the vane of the rotor that leave from or come to face the position of the stator core, so the vane of the rotor turns continually and the automatic permanent magnet electrical machinery export electricity to charge the battery (30) passing through the rectifying switching mode power supply (28) continually.

### Improvement of the Automatic Permanent Magnet Electrical Machinery:

The automatic permanent magnet electrical machinery can be putted perpendicularly or horizontally by changing the position of the machine seats (12). All switches can be instead by a PLC. The automatic permanent magnet electrical machinery can be started by a motor (5), it can also be started by the battery (30), coils (4,18) and an auto-control system or it can also be started manually. To reduce gravitation moment of the stator cores (3) and the vanes of the rotor, the number of the stator cores (3) and the vanes of the rotor can be more. To reduce start moment, use skeleton framework for big principal axis (13). For compact structure, use many layers of the design. Instead of the inefficient using of copper wire, use superconductor wire.

Another design of the position of the rotor cores (8) and stator cores (3) is to put the rotor cores (8) and stator cores (3) horizontally (FIG. 4), the plate shape automatic permanent magnet electrical machinery. The principle of the design is the same. The difference is top and bottom of the stator cores (3) and the rotor cores (8) become front and rear, as well as coils (4,18) on them. And front and rear position of the coils (4,18) of the stator core (3) changes as the rotor cores (8) turning. The connection between the middle coil (19) and front and rear coils (4, 18) is controlled by a PLC. The rotor core (8) and magnet (11) are fixed with two no magnetism plates (7,16) on top and bottom of them. The stator cores (3) with round shape are fixed in the shell (20) by the stator cores seats (32) and bolts (33) on the bottom lid (17).

The features of the invention are no other energy needed, no pollution, simple structure and economical.

1. The invention is the automatic permanent magnet electrical machinery, that is characterized by it is consists of a shell that installed with stator cores and a rotor as well as a control circuit; the shell consists of a top lid, a bottom lid and a shell body; the top lid has bolt holes and partition girders to lock stator cores; the bottom lid has a bearing seat, bolt holes, partition girders to lock the stator core and the holes for wire; the shell body also has bolt holes on each side to fix the top lid, the bottom lid and itself together with bolts; the shell body also has holes on the bottom for wire; the stator cores are made by soft magnetic material with the shape of c; the 3 coils are circled in the middle, top and bottom part of each stator core separately; the rotor is consists of the principal axis and many vanes; the principal axis is installed in the bearings in the bottom lid and a motor; the vane of the rotor is consists of a rotor core and a magnet embedded in the rotor core and fixed with no magnetism plate; the principal axis and the rotor cores are integral whole; the rotor core is made by soft magnetism material; the principal axis and the vanes of the rotor are fixed with two no magnetism plate; the another design of the position of the rotor core and stator cores is to put the rotor core and stator cores horizontally, the plate shape automatic permanent magnet electrical machinery.

2. According to the claim (1), the automatic permanent magnet electrical machinery is characterized by the number of the vanes of the rotor is the number of the stator cores minus or plus one.

3. According to the claim (1), the automatic permanent magnet electrical machinery is characterized by the coil in the middle of each stator core has a distance with the coil on the top part of the stator core and a distance with the coil on bottom part of the stator core.

4. According to the claim (1), the automatic permanent magnet electrical machinery is characterized by the number of the circles of the coil in the middle of each stator core is greater than total number of the circles of the coils in the top and bottom of the stator core.

5. According to the claim (1), the automatic permanent magnet electrical machinery is characterized by the coil in the middle of each stator core is series connected to the coils in the top and bottom of the stator core through a group switch of three.

6. According to the claim (1), the automatic permanent magnet electrical machinery is characterized by the wound directions of the coil in the middle of each stator core and the coils in the top and bottom of the stator core are opposite.

7. According to the claim (1), the automatic permanent magnet electrical machinery is characterized by the both coils on the top and on the bottom of each stator core are at the end of the stator core separately.

8. According to the claim (1), the automatic permanent magnet electrical machinery is characterized by the either of the coils on the top and bottom part of each stator core is divided to two parts.

9. According to the claim (1), the automatic permanent magnet electrical machinery is characterized by it can be used as an electromotor or a generator.

10. According to the claim (1), the automatic permanent magnet electrical machinery is characterized by it be started by the battery charged by itself.

11. According to the claim (1), the automatic permanent magnet electrical machinery is characterized by the outer arcs of the rotor cores are the parts of the same circle.

12. According to the claim (1), the automatic permanent magnet electrical machinery is characterized by the internal arcs of the stator cores in the machine are the parts of the same circle.

13. According to the claim (1), the automatic permanent magnet electrical machinery is characterized by all switches can be instead by a PLC.

14. According to the claim (1), the automatic permanent magnet electrical machinery is characterized by it can be started manually.

15. According to the claim (1), the automatic permanent magnet electrical machinery is characterized by the number of the stator cores (3) and the vanes of the rotor can be more.

16. According to the claim (1), the automatic permanent magnet electrical machinery is characterized by the skeleton framework can be used for big principal axis.

17. According to the claim (1), the automatic permanent magnet electrical machinery is characterized by the many layers of the design can be used.

18. According to the claim (1), the automatic permanent magnet electrical machinery is characterized by the superconductor wire can be used.

19. According to the claim (1), the automatic permanent magnet electrical machinery is characterized by its another design of the position of the rotor cores and stator cores is to put the rotor cores and stator cores horizontally.
